(19) United States
(12) Patent Application Publication
(10) Pub. No.: US 2013/0028731 A1
(43) Pub. Date: Jan. 31, 2013

(54) TILTING PAD JOURNAL BEARING AND STEAM TURBINE

(71) Applicants: Yuki MIMURA, Yokohama-shi (JP); Hitoshi SAKAKIDA, Tokyo (JP); Toshio HIRANO, Yokohama-shi (JP); Kazunori IKEDA, Yokohama-shi (JP); Kenichi KASE, Yokohama-shi (JP); Kenichi IMAI, Yokohama-shi (JP)

(72) Inventors: Yuki MIMURA, Yokohama-shi (JP); Hitoshi SAKAKIDA, Tokyo (JP); Toshio HIRANO, Yokohama-shi (JP); Kazunori IKEDA, Yokohama-shi (JP); Kenichi KASE, Yokohama-shi (JP); Kenichi IMAI, Yokohama-shi (JP)

(21) Appl. No.: 13/556,412

(22) Filed: Jul. 24, 2012

(30) Foreign Application Priority Data
Jul. 27, 2011 (JP) P2011-164405

(51) Int. Cl. F01D 25/16; F16C 17/03

(52) U.S. Cl. 415/229; 384/309

(57) ABSTRACT

In a tilting pad journal bearing device including a plurality of arc-shaped pads 3₁, 3₂, . . . , 3₆ which are incorporated in a bearing inner ring 4 swingably in a circumferential direction of a journal 2, a load applied to each of the pads 3₁, 3₂, and 3₆ disposed in a lower half portion of the bearing inner ring 4 has anisotropy.

### CROSS-REFERENCE TO RELATED APPLICATION

This application is based upon and claims the benefit of priority from the prior Japanese Patent Application No. 2011-164405, filed on Jul. 27, 2011; the entire contents of which are incorporated herein by reference.

### FIELD

Embodiments described herein related generally to a tilting pad journal bearing and a steam turbine.

### BACKGROUND

In a journal bearing stably supporting a rotation shaft of a steam turbine or a large, high-speed rotary machine such as a generator driven by this steam turbine, normally, a tilting pad journal bearing is employed.

FIG. 7 is a transverse sectional view schematically illustrating a conventional tilting pad journal bearing stably supporting a rotation shaft of a steam turbine or a generator.

FIG. 8 is an enlarged view depicting an arbitrary one of a plurality of pads 3.

As illustrated in FIG. 7, the tilting pad journal bearing 1 has a plurality (six in FIG. 7) of arc-shaped pads 3 (3₁, 3₂, 3₃, . . . , 3₆) disposed at substantially equal intervals in a rotational direction indicated by arrow of a journal (journal part) 2 of a rotation shaft of a steam turbine or a generator, and a bearing inner ring 4 (4₁, 4₂) divided in two in arc shapes and supporting the respective pads 3₁, 3₂, 3₃, . . . , 3₆ in a manner of surrounding from an outer side. Further, in the tilting pad journal bearing 1, back faces of the respective pads 3₁, 3₂, 3₃, . . . , 3₆ are supported by pivots 5 (5₁, 5₂, 5₃, . . . , 5₆) attached to the bearing inner ring 4, thereby allowing the respective pads 3₁, 3₂, 3₃, . . . , 3₆ to swing with respect to movement of the journal 2.

In practice, there is a bearing outer ring (not illustrated) on an outer side of the bearing inner ring 4, and the bearing outer ring is structured to be fixed to a bearing casing or a base.

In the tilting pad journal bearing 1 structured thus, lubricating oil is used as a lubricant. The lubricating oil is moved by friction occurring between the journal 2 which is rotating and the pads 3 which are stationary bodies, and is thereby supplied between the journal 2 and the respective pads 3.

In FIG. 8, there are described a straight line L1 (namely, straight line L1 indicated by a dot and dash line passing through the center position of a pad 3) passing through a center of curvature Ob of an inner face 4a of the bearing inner ring 4, a center of curvature Op of a sliding face 3a of the pad 3, and a center of gravity G of the pad 3. Further, there is described a straight line L2 perpendicular to the straight line L1 from the center of gravity G of the pad 3. Then, this perpendicular straight line L2 is a reference angle (0°) of a tilt angle (swing angle) α of the pad 3. Here, the angle of the pad 3 when tilting in a counterclockwise direction about the pivot 5 being a fulcrum is defined as a positive (+) side, and the angle when tilting conversely in a clockwise direction is defined as a negative (−) side. In this case, if the journal 2 rotates in a counterclockwise direction as indicated by arrow, the pad 3 tilts in the counterclockwise direction, and hence the tilt angle (swing angle) α of the pad 3 becomes positive (+).

As described above, the lubricating oil is supplied to a gap C between the journal 2 and the pad 3 by rotation of the journal 2. At this time, the pad 3 is stationary while the journal 2 rotates at high circumferential speed, and thus a quite large speed difference occurs between the journal 2 side and the pad 3 side in the lubricating oil supplied to the gap C between the sliding face 2a of the journal 2 and the lubricating face 3a of the pad 3.

When a speed difference occurs in the lubricating oil, shearing force operates to the lubricating oil, and viscous force occurs inside the lubricating oil. Then, by this viscous operation and the tilting state of the pad 3 formed from movements of the journal 2 and the pad 3, a “wedge effect” occurs between them. Accordingly, oil film pressure distributions P6, P1, and P2 as illustrated in FIG. 7 occurs in the lubricating oil supplied to the gap C between the journal 2 and the three pads 3₆, 3₁, and 3₂ in a lower half portion supporting the load applied to the journal 2.

When the oil film pressure distributions P6, P1, and P2 occurring to the respective pads 3₆, 3₁, and 3₂ in the lower half portion are integrated through the entire circumference, the result corresponds to the load W applied to the journal 2. Here, describing the pad 3₁ at a lowest part (directly below), a contact point T1 between a back face of the pad 3₁ and the pivot 5₁ moves freely to be located vertically below the center point of the oil film pressure distribution P1 which varies according to the rotation of the journal 2. Such a phenomenon similarly occurs to the pad 3₂ and the pad 3₆ which are adjacent to both sides of the pad 3₁ of the lowest part (directly below).

In this manner, the pads 3 automatically align and receive the bearing load W entirely, preventing occurrence of unstable force which causes oil whip. Thus, the tilting pad journal bearing 1 has an automatic alignment function and excels in stability, and is hence used for a high-speed rotary machine which is required in particular to have high stability.

However, since the pads 3 vibrate by swinging, asynchronous vibrations may occur and cause unstableness. To prevent this, there has been suggested to form a trench in the vicinity of end portions of the pads, so as to prevent flowing out of the lubricating oil by flow of the lubricating oil in the trench.

However, in recent years, as a consequence of increasing tendencies for size enlargement and speed increase of steam turbines and generators, unstable vibrations occur more easily even in the tilting pad journal bearings having excellent stability. Moreover, in order to improve performance of steam turbines, there are significant tendencies for increase in turbine stage number, reduction in leakage loss, temperature increase, and pressure increase. Accompanying this, stability with respect to vibrations of a shaft system has been decreasing, such as decrease in dangerous speed of shaft system, decrease in system attenuation, increase in destabilization seal force, and so on.

Among them, unstable vibrations having the following characteristics are recognized.

When there is load dependency and while the load is small, no vibration occurs, or even when vibrations occur, there is no problem since the amplitude of the vibrations is small. However, as the load gets bigger, vibrations occur for the first time or the amplitude suddenly increases and cause intense vibrations, and it becomes difficult to increase the load further.

Further, there are many examples that unstable vibrations occur in an area where the vibration frequency is close to a primary natural frequency, and the rotation speed of the shaft exceeds primary dangerous speed. Therefore, the vibration frequency is lower than a rotation synchronous vibration frequency. A cause of occurrence of such vibrations is fluid force, which is called destabilization force and is often modeled with a coupled spring term as in the following equation (1).

$$\begin{matrix}[ Equation 1 ] & \\ Destabilizing force = - [ \begin{matrix}0 & {k}_{xy} \\ {k}_{yx} & 0\end{matrix} ] [ \begin{matrix}x \\ y\end{matrix} ] & ( 1 )\end{matrix}$$

### BRIEF DESCRIPTION OF THE DRAWINGS

FIG. 1 is a cross-sectional view illustrating a lower half portion of a tilting pad journal bearing according to Embodiment 1.

FIG. 2 is a characteristic diagram illustrating the relation between a pad fulcrum position and a load applied to a pad.

FIG. 3 is a view illustrating an effect when anisotropy applied to the pad is increased.

FIG. 4 is a cross-sectional view illustrating a lower half portion of a tilting pad journal bearing according to Embodiment 2.

FIG. 5 is a cross-sectional view illustrating a lower half portion of a tilting pad journal bearing according to Embodiment 3.

FIG. 6 is a cross-sectional view illustrating a lower half portion of a tilting pad journal bearing according to Embodiment 4.

FIG. 7 is a cross-sectional view illustrating a tilting pad journal bearing of a conventional art.

FIG. 8 is an enlarged explanatory view of one pad in FIG. 7.

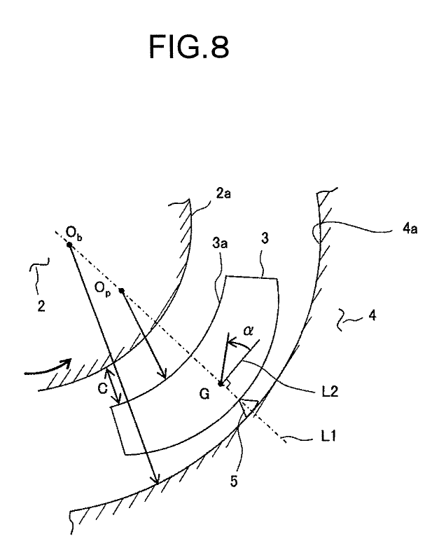

FIG. 9 is an explanatory view for obtaining the characteristic diagram of FIG. 2.

### DETAILED DESCRIPTION

A tilting pad journal bearing of this embodiment includes a plurality of arc-shaped pads which are incorporated in a bearing inner ring swingably in a circumferential direction of a journal, wherein a load applied to each of the pads disposed in a lower half portion of the bearing inner ring has anisotropy.

Further, a steam turbine of this embodiment includes the tilting pad journal bearing according to any one of claims 1 to 5, wherein a journal of a steam turbine rotation shaft is supported by the tilting pad journal bearing in an automatically aligning manner.

Hereinafter, embodiments of a tilting pad journal bearing according to the present invention will be described with reference to the drawings. Note that the same parts and components are denoted by the same reference numerals throughout the drawings, and duplicated description is omitted appropriately.

### Embodiment 1

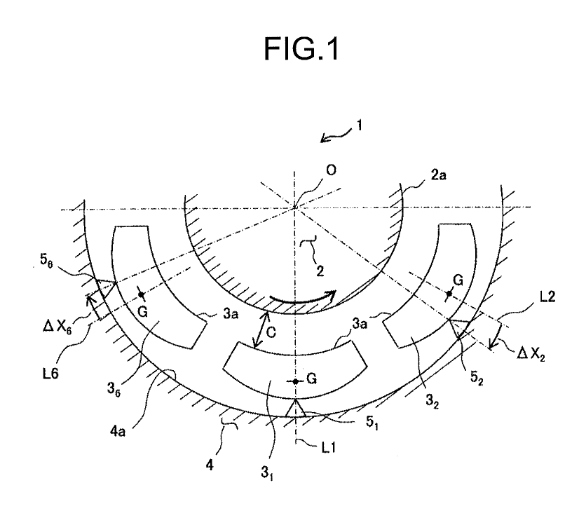

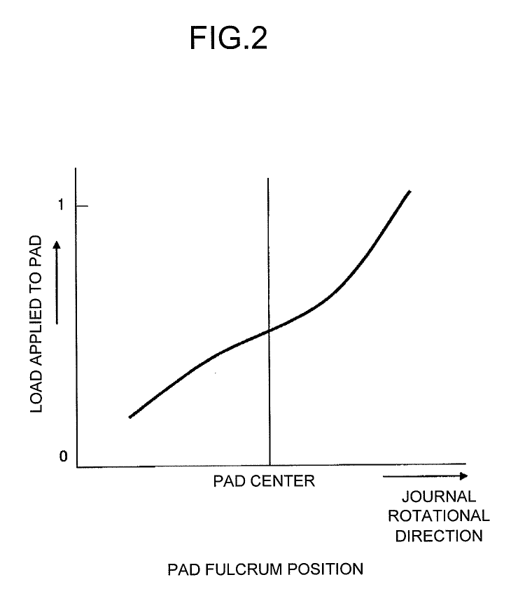

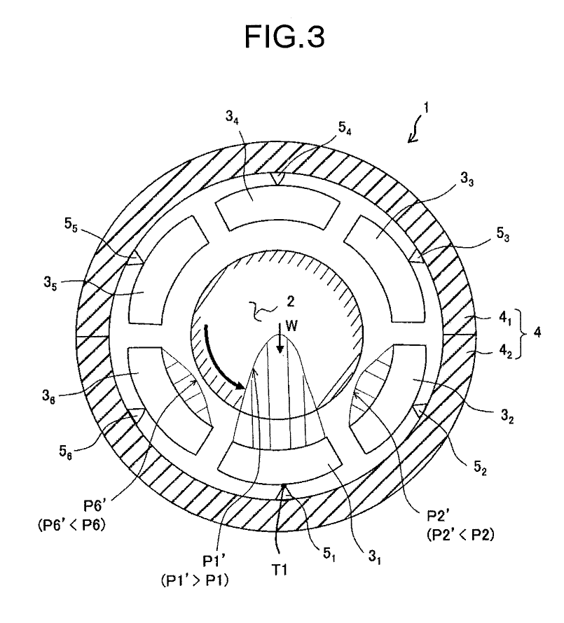

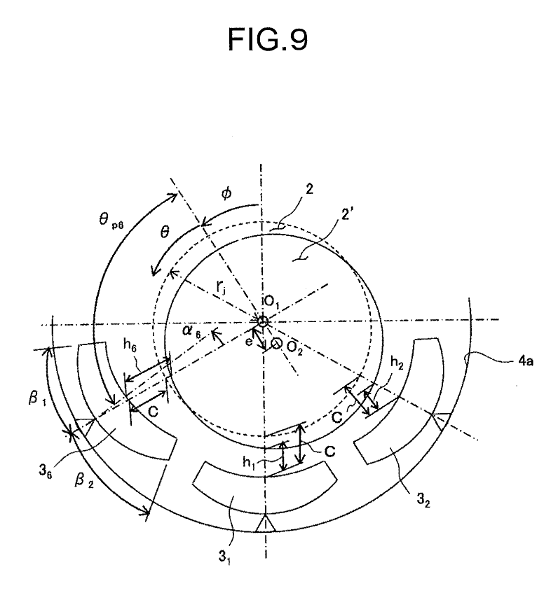

Embodiment 1 will be described with reference to FIG. 1, FIG. 2, FIG. 3, and FIG. 9.

### (Structure)

FIG. 1 is a cross-sectional view illustrating a lower half portion of a tilting pad journal bearing according to Embodiment 1.

As illustrated in FIG. 1, among pads 3₁, 3₂, and 3₆ disposed in the lower half portion of the tilting pad journal bearing 1, the pad 3₁ disposed at a lowest part, that is, directly below, is supported at its back face by a pivot 5₁ disposed on a straight line L1 (straight line connecting the center of gravity G of the pad 3₁ and the rotation center O of the journal 2) passing through a center position of this pad 3₁.

However, the pads (adjacent pads on the front side and back side, respectively, in the rotational direction of the journal 2) 3₂ and 3₆ located on the left and right sides in a horizontal direction of this pad 3₁ at the lowest part are supported at their back faces by pivots 5₂ and 5₆ disposed at positions moved (displaced) backward in the rotational direction (reverse rotational direction) of the journal 2 by predetermined angles Δx₂ and Δx₆ from straight lines L2 and L6 (straight lines connecting the centers of gravity G of the pads 3₂, 3₆ and the rotation center O of the journal 2) passing through respective center positions of the pads 3₂, 3₆ being a base point. Note that a moving angle (also referred to as a displacement angle) Δx₂ of the pivot 5₂ and a moving angle Δx₆ of the pivot 5₆ may be the same angles or different angles.

### (Operation)

FIG. 2 is a diagram illustrating a variation of the load applied to a pad when a pad fulcrum position is moved.

FIG. 2 illustrates that when the fulcrum position of the pad 3 moves to a forward position from the center of the pad 3 in the rotational direction of the journal 2, a swing angle (α) of the pad 3 tilts in a positive direction to increase “wedge effect”, and the load applied to the pad 3 increases. At the same time, FIG. 2 illustrates that when the fulcrum position of the pad 3 moves to a backward position in the rotational direction of the journal 2, the swing angle (α) of the pad 3 tilts in a negative direction to decrease the “wedge effect”, and the load applied to the pad 3 decreases.

Note that as will be described below, the characteristic diagram of FIG. 2 is obtained by simulating logical formulas obtained from a lubrication equation (3) (equation (4) related to a balance of moment around a pivot and equation (5) related to a balance between the load applied to a pad and oil film force) on a computer.

FIG. 9 is an explanatory view for obtaining the characteristic diagram of FIG. 2.

As illustrated in FIG. 9, between the journal 2 and the respective pads 3₁, 3₂, 3₆ in the lower half portion, a gap C corresponding to the difference between the pad 3 inner face and a radius rⱼ of the journal 2 is provided. When the journal 2 rotates, the journal 2 lowers to a position where the oil film force formed in the gap C between this journal 2 and the pad 3 balances with the weight of the journal 2 (the journal illustrated by a dashed line is at the position of numeral 2′). Accordingly, the center of the journal 2 moves to a position O₂ decentered by a decentering amount e from a position O₁ before rotating.

Gaps H₁, H₂, H₆ formed between the journal 2′ after moved and the respective pads 3 are represented by following equation (2).

$$\begin{matrix}[ Equation 2 ] & \\ \begin{matrix}{h}_{i} = C + e cos θ + {α}_{i} r sin ( {θ}_{pi} - θ ) \\ = C ( 1 + ɛ \cdot cos θ ) + {α}_{i} r sin ( {θ}_{pi} - θ ) ( i = each of the pads )\end{matrix} & ( 2 )\end{matrix}$$

Here, ε represents e/C and means a decentering ratio. Φ represents an angle in a circumferential direction from the original journal 2 based on a decentering direction O₁-O₂ of FIG. 9. Further, α6 represents a tilt of the pad 3₆. β₁, β₂ represent a length from the fulcrum position of the pad 3₆ to a rear end and a front end in the rotational direction of the journal 2.

Further, rⱼ represents a radius of the journal 2, and Oₚ₆ represents an angle from a straight line connecting the decentering direction O₁-O₂ to the fulcrum of the pad 3₆.

In such a tilting pad journal bearing, the oil film pressure p of the bearing occurring in each pad 3 with respect to the weight of the journal 2′ itself is obtained from the lubrication equation illustrated in following equation (3), where θ represents a coordinate in a circumferential direction and z represents a coordinate in an axial direction.

$$\begin{matrix}[ Equation 3 ] & \\ \frac{\partial }{\partial θ} ( \frac{{h}_{i}^{3}}{12 μ} \frac{\partial {p}_{i}}{\partial θ} ) + \frac{\partial {p}_{i}}{\partial z} ( \frac{{h}_{i}^{3}}{12 μ} \frac{\partial {p}_{i}}{\partial θ} ) = \frac{U}{2} \frac{\partial {h}_{i}}{\partial θ} \\ ( i = each of the pads ) & ( 3 )\end{matrix}$$

Here, μ represents the temperature of lubricating oil, and U represents the circumferential speed of the journal. In the tilting pad journal bearing, on a pad surface, the oil film pressure occurs so that the moment around the pivot disposed at substantially the center of the pad becomes zero on the pad surface. When the moment of the pad is ignored, equation (4) is obtained from the balance of moment around the pivot. Then, equation (5) is obtained from the balance between a load Wₚᵢ applied on the pad and oil film force.

[Equation 4]

0=∫₀¹∫_{θ}_{₁}^{θ}^{₂}pᵢ cos(θₚᵢ−θ)dθdz (i=each of the pads) (4)

Wₚᵢ=∫₀¹∫_{θ}_{₁}^{θ}^{₂}pᵢ sin(θₚᵢ−θ)dθdz (i=each of the pads) (5)

By simulating logical formulas represented by these equations (4), (5) on a computer, the above-described result of FIG. 2 can be obtained.

As is clear from the above-described FIG. 2, the support positions of the pads 3₂ and 3₆ located on the left and right sides in a horizontal direction of the pad 3₁ located directly below are moved in the reverse direction of the rotational direction of the journal 2 from the positions on the straight line connecting the centers of gravity G of the pads 3₂, 3₆ and the rotation center O of the journal 2. Accordingly, the loads applied to the respective pads 3₂ and 3₆ decrease, and mainly the oil film force in the horizontal direction decreases. Accompanying this, the load applied to the pad 3₁ located directly below increases, and the oil film force in a vertical direction increases. That is, anisotropy of the bearing oil film force increases.

FIG. 3 is a view illustrating the relation between a pressure distribution P1′ of the pad 3₁ at the lowest part (directly below) of the journal 3 at this time and the pressure distributions P2′, P6′ of the pads 3₂, 3₆ on the left and right sides in the horizontal direction.

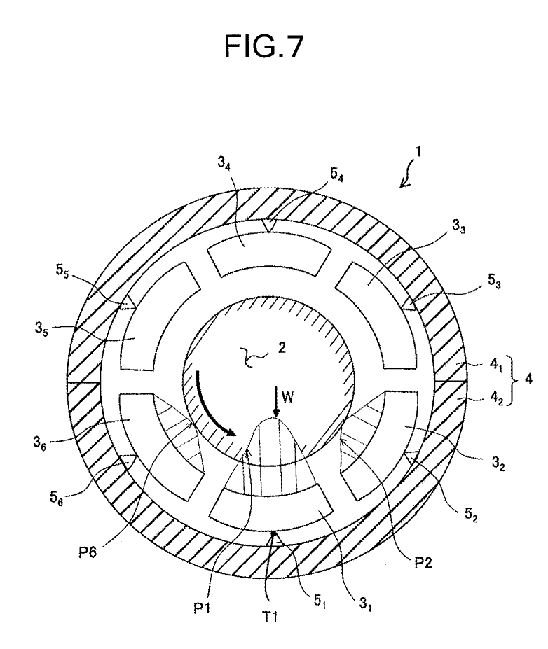

As can be seen from FIG. 3, among the respective pads 3₁, 3₂, 3₆ disposed in the lower half portion, pressure distributions P2′, P6′ of the pads 3₂, 3₆ adjacent on the left and right sides in the horizontal direction (front side and back side in the rotational direction of the journal 2) relative to the pad 3₁ located at the lowest part are smaller than the pressure distributions P2, P6 of the case illustrated in FIG. 7 (P2′<P2, P6′<P6).

As a result, the pressure distribution P1′ on the pad 3₁ located at the lowest part (directly below) of the journal 3 is larger than the pressure distribution P1 of the case illustrated in FIG. 7 (P1′>P1), and thus the anisotropy of the bearing oil film force increases.

### (Effect)

As described above, the tilting pad journal bearing 1 of this embodiment has a bearing inner ring 4 disposed around an outer peripheral face of the journal 2, a plurality of arc-shaped pads 3₁₋₆ disposed at equal intervals in the circumferential direction of the journal 2 between the outer peripheral face of the journal 2 and an inner peripheral face of the bearing inner ring 4, and pivots 5₁₋₆ which are disposed on the inner peripheral face of the bearing inner ring 4 and swingably support the pads 3₁₋₆, and the lubricating oil is supplied to the gap C between the pads 3₁₋₆ and the journal 2 by rotation of the journal 2. Here, among the pads 3₁₋₆, the pad 3₁ located at the lowest part is supported at its outer peripheral face by the pivot 5₁ disposed on the straight line connecting the center of gravity G of this pad 3₁ and the rotation center O of the journal 2. Then, with respect to the pad 3₁ at the lowest part, the pad 3₂ disposed on an adjacent front side and the pad 3₆ disposed on an adjacent back side in the rotational direction of the journal 2 are supported at their outer peripheral faces by the pivots 5_{2,6} disposed on the back side in the rotational direction of the journal 2 from the straight line connecting the centers of gravity G of these pads 3_{2,6} and the rotation center O of the journal 2 (see FIG. 1). Thus, according to Embodiment 1, as described above, the anisotropy of the bearing oil film force increases (see FIG. 3). Therefore, this embodiment can prevent occurrence of unstable vibrations due to destabilizing force from operating fluid, and it is possible to provide a tilting pad journal bearing with good stability.

### Embodiment 2

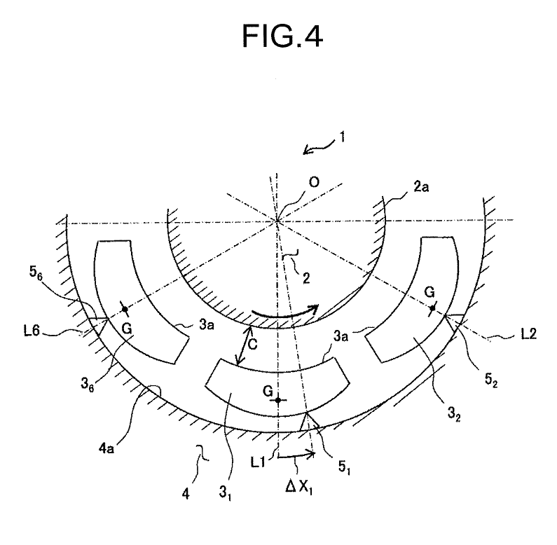

Hereinafter, Embodiment 2 of the present invention will be described with reference to FIG. 4.

### (Structure)

FIG. 4 is a cross-sectional view illustrating a lower half portion of a tilting pad journal bearing according to Embodiment 2 of the present invention.

As illustrated in FIG. 4, in this Embodiment 2, unlike Embodiment 1 illustrated in FIG. 1, the position of the pivot 5₁ supporting the pad 3₁ at the lowest part (directly below) is at a position moved forward in the rotational direction of the journal 2 by an angle Δxᵢ from the center of the pad 3₁, that is, the straight line L1 connecting the center point O of the journal 2 and the center of gravity of this pad 3₁. Besides this, in Embodiment 2, the positions of pivots 5₂ and 5₆ supporting the pads 3₂ and 3₆, respectively, which are adjacent to the pad 3₁ directly below, are the same as in the conventional example of FIG. 7. That is, the pivots 5₂ and 5₆ supporting the pads 3₂ and 3₆, respectively, are disposed on the straight lines L2 and L6 passing through the center positions of the pads 3₂ and 3₆.

### (Operation)

In Embodiment 2, the supporting position for the pad 3₁ at the lowest part (directly below) is moved forward in the rotational direction of the journal 2 from the center position of this pad 3₁. Accordingly, the load applied to this pad 3₁ increases, and the oil film force in the vertical direction increases. That is, it becomes possible to increase the anisotropy of the bearing oil film force.

### (Effect)

As described above, according to Embodiment 2, the anisotropy of the bearing oil film force increases, occurrence of unstable vibrations due to destabilizing force from operating fluid can be prevented, and it is possible to provide a tilting pad journal bearing with good stability.

### Embodiment 3

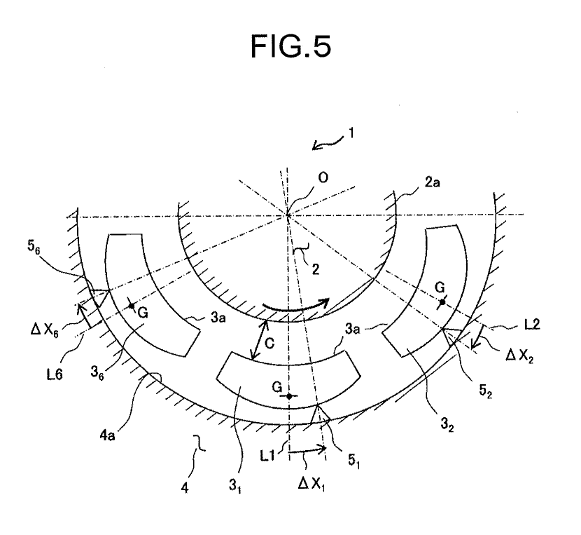

Hereinafter, Embodiment 3 of the present invention will be described with reference to FIG. 5.

### (Structure)

FIG. 5 is a cross-sectional view illustrating a lower half portion of a tilting pad journal bearing according to Embodiment 3.

This embodiment is made by combining the technical ideas of Embodiment 1 and the technical ideas of Embodiment 2 which are described above. Specifically, the disposing position of the pivot 5₁ supporting the pad 3₁ at the lowest part (directly below) is moved forward by the angle Δx₁ in the rotational direction of the journal 2 from the center position on the straight line L1. Then, the disposing positions of the pivots 5₁ and 5₆ supporting the pads 3₂ and 3₆ adjacent to the pad 3₁ at the lowest part (directly below) are moved by the angles Δx₂, Δx₆ in a reverse rotational direction (backward in the rotational direction) of the journal 2, respectively, from the center positions on the straight lines L2, L6.

### (Operation)

Since the supporting position of the pad 3₁ at the lowest part (directly below) is moved in the rotational direction of the journal 2 from the pad center position, the load applied to the pad 3₁ increases. In addition, since the supporting positions of the adjacent pads 3₂ and 3₆ are moved in the reverse rotational direction of the journal 2, the loads applied to these pads 3₂ and 3₆ decrease, the oil film force mainly in the horizontal direction decreases, and the load applied to the pad 3₁ increases further. That is, it becomes possible to increase the anisotropy of the bearing oil film force.

### (Effect)

As described above, according to Embodiment 2, the anisotropy of the bearing oil film force increases largely, occurrence of unstable vibrations due to destabilizing force from operating fluid can be prevented, and it is possible to provide a tilting pad journal bearing with good stability. Note that in this embodiment, it is possible to prevent occurrence of unstable vibrations due to destabilizing force larger than that in Embodiments 1, 2.

### Embodiment 4

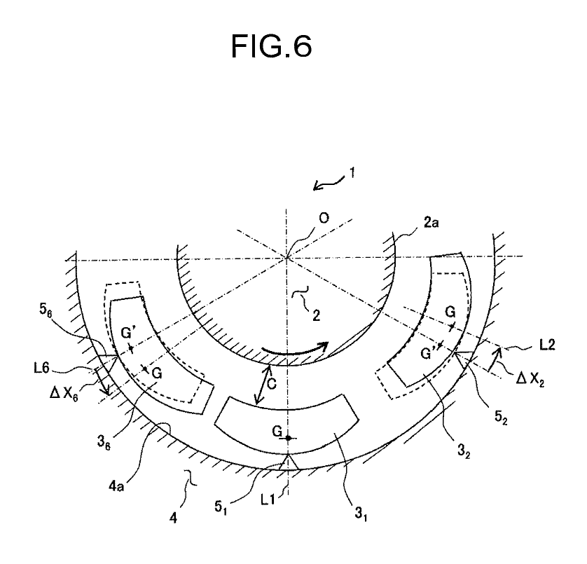

Hereinafter, Embodiment 4 of the present invention will be described with reference to FIG. 6.

### (Structure)

FIG. 6 is a cross-sectional view illustrating a lower half portion of a tilting pad journal bearing according to Embodiment 4.

This Embodiment 4 is such that the disposing positions of the pivots 5 as fulcrums of the pads 3 are not moved, but the pads 3 themselves are allowed to move.

As illustrated in FIG. 6, among the pads 3₁, 3₂, 3₆ disposed in the lower half of the tilting pad journal bearing 1, the pad 3₁ at the lowest part (directly below) is not allowed to move. Then, only the pads 3₂, 3₆ located on the left and right sides of the pad 3₁ at the lowest part (directly below) are allowed to move forward in the rotational direction of the journal 2 by an angle Δx. Here, in FIG. 6, regarding the left and right pads 3₂ and 3₆, dashed lines indicate the positions of the pads 3₂, 3₆ before moving, and solid lines indicate the positions of the pads 3₂, 3₆ after moving in the rotational direction of the journal 2 by the angle Δx. Note that G′ denotes a center of gravity before moving, and G denotes a center of gravity after moving.

### (Operation)

As illustrated in FIG. 6, when the pads 3₂ and 3₆ disposed on the left and right sides of the pad 3₁ at the lowest part (directly below) are allowed to move in the rotational direction of the journal 2, similarly to the case of Embodiment 1 (FIG. 1) in which the pivots 5₂, 5₆ supporting the pads 3₂, 3₆ are moved backward in the rotational direction of the journal 2, the swing angles α of the pads tilt in a negative direction to weaken the “wedge effect”, making it possible to decrease the loads applied to the pads 3₂ and 3₆.

Conversely, when the pads 3₂ and 3₆ disposed on the left and right sides of the pad 3₁ at the lowest part (directly below) are allowed to move in the reverse direction (clockwise direction) of the rotational direction of the journal 2 indicated by arrow, the swing angles α of the pads become small, the oil film force in the vertical direction increases, and the anisotropy of the bearing oil film force increases.

Note that although in the example illustrated in FIG. 6 the left and right pads 3₂, 3₆ are moved in the rotational direction of the journal 2 by the angle Δx, it may be structured to allow the pad 3₁ at the lowest part (directly below) to move in the reverse rotational direction (clockwise direction) of the journal 2. In this case, similarly to the case of Embodiment 2 (FIG. 4) in which the pivot 5₁ supporting the pad 3₁ is moved in the rotational direction of the journal 2 indicated by arrow, it becomes possible to strengthen the wedge effect.

### (Effect)

As has been described, according to Embodiment 4, the anisotropy of bearing oil film force increases largely, occurrence of unstable vibrations due to destabilizing force from operating fluid can be prevented, and it is possible to provide a tilting pad journal bearing with good stability.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A tilting pad journal bearing including a plurality of arc-shaped pads configured to be incorporated in a bearing inner ring swingably in a circumferential direction of a journal,
wherein a load applied to each of the pads disposed in a lower half portion of the bearing inner ring has anisotropy.

2. The tilting pad journal bearing according to claim 1,
wherein, among the pads disposed in the lower half portion, a pad support point of a pad adjacent to a pad located at a lowest part is moved in a reverse direction of a rotational direction of the journal.

3. The tilting pad journal bearing according to claim 1,
wherein, among the pads disposed in the lower half portion, a pad support point of a pad located at a lowest part is moved in a same direction as a rotational direction of the journal.

4. The tilting pad journal bearing according to claim 1,
wherein, among the pads disposed in the lower half portion, a pad support point of a pad located at a lowest part is moved in a same direction as a rotational direction of the journal, and a pad support point of a pad adjacent to the pad located at the lowest part is moved in a reverse direction of the rotational direction of the journal.

5. The tilting pad journal bearing according to claim 1,
wherein, among the pads disposed in the lower half portion, a pad support point of a pad adjacent to a pad located at a lowest part is not moved, and the adjacent pad itself is allowed to move in a rotational direction of the journal.

6. A steam turbine including the tilting pad journal bearing according to claim 1,
wherein a journal of a steam turbine rotation shaft is supported by the tilting pad journal bearing in an automatically aligning manner.
